(19) United States
(12) Patent Application Publication
(10) Pub. No.: US 2025/0202185 A1
(43) Pub. Date: Jun. 19, 2025

(54) LASER DEVICE FOR CONTROLLING INTERNAL RESONANCE USING POLARIZATION CROSS-COUPLING OF OPTICAL FIBERS

(71) Applicant: PUSAN NATIONAL UNIVERSITY INDUSTRY-UNIVERSITY COOPERATION FOUNDATION, Busan (KR)

(72) Inventors: Changseok KIM, Busan (KR); Seongjin BAK, Busan (KR); Gyeonghun KIM, Busan (KR); Hwidon LEE, Busan (KR)

(73) Assignee: PUSAN NATIONAL UNIVERSITY INDUSTRY-UNIVERSITY COOPERATION FOUNDATION, Busan (KR)

(21) Appl. No.: 18/976,582

(22) Filed: Dec. 11, 2024

(30) Foreign Application Priority Data
Dec. 15, 2023 (KR) 10-2023-0182625

(51) Int. Cl. H01S 3/08; H01S 3/067

(52) U.S. Cl. CPC H01S 3/08013; H01S 3/06791

(57) ABSTRACT

A laser device controlling internal resonance using polarization cross-coupling of optical fibers, includes a laser resonator including polarization-maintaining optical fibers; an optical gain modulator configured to oscillate broadband light with the laser resonator; a symmetric dispersion inducer repeating compression and stretching of the light oscillated from the optical gain modulator; first and second optical circulators connecting the symmetric dispersion inducer to the laser resonator; a polarization cross-coupler suppressing internal resonance in a direction transmitted through the symmetric dispersion inducer via the first and second optical circulators; and an optical coupler making an output port by dividing the light amplified from the laser resonator at a constant ratio.

### CROSS-REFERENCE TO RELATED APPLICATION

This application claims the benefit of Korean Patent Application No. 10-2023-0182625 filed on Dec. 15, 2023, in the Korean Intellectual Property Office, the entire disclosure of which is incorporated herein by reference for all purposes.

### ACKNOWLEDGEMENT

This work was supported by the National Research Foundation of Korea (NRF) grant funded by the Korea government (MSIT) (No. NRF-2021R1A5A1032937).

This work was supported by Korea Evaluation Institute of Industrial Technology (KEIT) grant funded by the Korea government (MOTIE) (No. 20026554).

### BACKGROUND

The present disclosure relates to a laser device, and specifically to a laser device that controls internal resonance using polarization cross-coupling of optical fibers to address the problem of a laser output duty ratio being limited to 50% or less, which was caused by suppressing lasing of light transmitted through a symmetric dispersion inducing optical element in a laser setup via on/off control of an optical gain element.

Problems of suppressing unnecessary first resonance through on/off control of a laser device according to a related art are described as follows.

FIG. 1 is a diagram to illustrate the problem of suppressing first resonance through on/off in a laser device according to the related art.

When on/off control is not applied, both first resonance and second resonance are lasing, and when on/off control is applied, first resonance can be suppressed, and second resonance can be lasing.

However, there is a limitation in that the duty cycle can only be generated below 50%.

As such, in a laser setup according to the related art, on/off control of an optical amplifier was necessary to suppress unnecessary internal resonance, which led to the problem of the duty ratio being limited to 50% or less.

In addition, in the case of lasers that repeat compression and stretching according to the related art, compression and stretching are induced through reflections at different positions for each wavelength in the symmetric dispersion inducing optical element.

However, unnecessary internal resonance occurs due to the light transmitted through the symmetric dispersion inducing optical element, and on/off control of an optical amplifier was necessary to suppress this, which led to the problem of the laser output duty ratio being limited to 50% or less.

Therefore, there is a need for the development of new technology that can solve the problems of the duty ratio being limited to 50% or less in the laser setup according to the related art.

### PRIOR-ART DOCUMENTS

### Patent Documents

(Patent Document 1) Korean Patent Application Publication No. 10-1998-0050574
(Patent Document 2) Korean Patent Application Publication No. 10-2014-0052116
(Patent Document 3) Korean Patent Application Publication No. 10-2016-0109809

### SUMMARY

An aspect of the present disclosure is to solve the problems of laser devices according to the related art and to provide a laser device that controls internal resonance using polarization cross-coupling of optical fibers to address the problem of the laser output duty ratio being limited to 50% or less, which was caused by suppressing lasing of light transmitted through the symmetric dispersion inducing optical element in the laser setup via on/off control of the optical gain element.

An aspect of the present disclosure is to provide a laser device that controls internal resonance using polarization cross-coupling of optical fibers, which suppresses the resonance of light transmitted through the symmetric dispersion inducing optical element without on/off control of the optical gain element, by using a polarization cross-coupler that cross-couples polarization axes perpendicularly, thereby increasing the laser output duty ratio to over 50%.

Other objects of the present disclosure are not limited to the aforementioned objects, and additional objects not mentioned can be clearly understood by those skilled in the art from the following description.

A laser device for controlling internal resonance using polarization cross-coupling of optical fibers according to the present disclosure to achieve the aforementioned objects includes: a laser resonator including polarization-maintaining optical fibers; an optical gain modulator configured to oscillate broadband light with the laser resonator; a symmetric dispersion inducer repeating compression and stretching of the light oscillated from the optical gain modulator; first and second optical circulators connecting the symmetric dispersion inducer to the laser resonator; a polarization cross-coupler suppressing internal resonance in a direction transmitted through the symmetric dispersion inducer via the first and second optical circulators; and an optical coupler making an output port by dividing the light amplified from the laser resonator at a constant ratio.

Here, the first optical circulator may receive light from the optical gain modulator at a first port and send it to the symmetric dispersion inducer connected to a second port, and receive the stretched light from the symmetric dispersion inducer at the second port and output it to a third port, and the second optical circulator may receive light from the third port within the first optical circulator at a first port and send it to the symmetric dispersion inducer connected to a second port, and receive the compressed light from the symmetric dispersion inducer at the second port and output it to a third port.

Further, the symmetric dispersion inducer may be connected to the first optical circulator to induce the stretching of light and being connected to the second optical circulator to induce the compression of light.

Further, the polarization cross-coupler may be configured such that a polarization axis of polarization-maintaining optical fiber in either a second port within the first optical circulator or a second port within the second optical circulator is connected in a direction perpendicular to a polarization axis of polarization-maintaining optical fiber in the symmetric dispersion inducer, thereby suppressing internal resonance in a direction transmitted through the symmetric dispersion inducer via the corresponding optical circulator.

Further, the optical coupler may include one or more of either a first optical coupler, positioned in the laser resonator and outputting the compressed light to the outside, or a second optical coupler, positioned in the laser resonator and outputting the stretched light to the outside. Further, the laser device may further include an optical modulator generating broadband light as pulsed light.

Further, the laser device may further include an optical amplifier generating the broadband light as pulsed light.

Further, the laser device may further include a discontinuous symmetric dispersion inducer repeating compression and stretching of the light oscillated from the optical gain modulator discontinuously according to a wavelength instead of the symmetric dispersion inducer.

A laser device that controls internal resonance using polarization cross-coupling of optical fibers according to the present disclosure, as described above, has the following effects.

First, it may solve the problem of the laser output duty ratio being limited to 50% or less, which was caused by suppressing the lasing of light transmitted through the symmetric dispersion inducing optical element in the laser setup via the on/off control of the optical gain element.

Second, by using a polarization cross-coupler that cross-couples the polarization axes perpendicularly, it may suppress the resonance of light transmitted through the symmetric dispersion inducing optical element without on/off control of the optical gain element, allowing the laser output duty ratio to be increased to over 50%.

### BRIEF DESCRIPTION OF THE DRAWINGS

FIG. 1 is a diagram to illustrate the problem of suppressing first resonance through on/off in a laser device according to the related art.

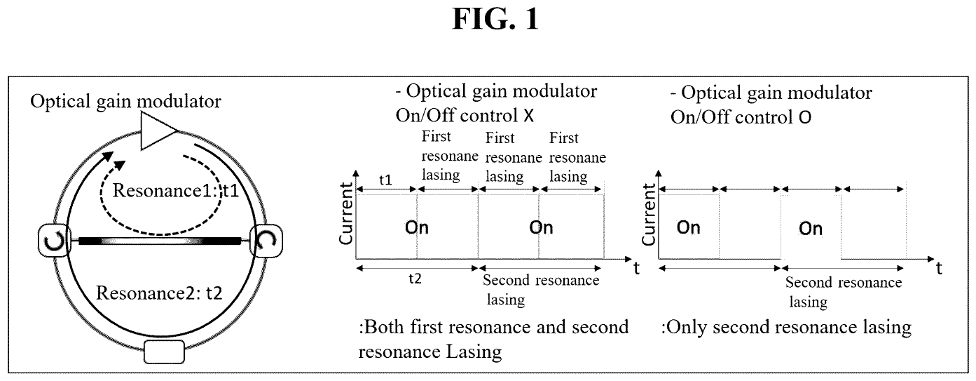

FIG. 2 is a diagram to illustrate the basic structure of a laser device that controls internal resonance using polarization cross-coupling of optical fibers according to the present disclosure.

FIG. 3 is a diagram to illustrate the configuration of a laser device that controls internal resonance using polarization cross-coupling of optical fibers according to another embodiment of the present disclosure.

FIG. 4 is a diagram to illustrate the configuration of a laser device that controls internal resonance using polarization cross-coupling of optical fibers according to yet another embodiment of the present disclosure.

FIG. 5 is a diagram to illustrate the configuration of a laser device that includes a discontinuous symmetric dispersion inducer.

FIG. 6 is a diagram to illustrate the operational characteristics of a laser device that controls internal resonance using polarization cross-coupling of optical fibers according to the present disclosure.

### DETAILED DESCRIPTION

Hereinafter, preferred embodiments of a laser device that controls internal resonance using polarization cross-coupling of optical fibers according to the present disclosure will be described in detail as follows.

The features and advantages of the laser device that controls internal resonance using polarization cross-coupling of optical fibers according to the present disclosure will become apparent through the detailed descriptions of the following embodiments.

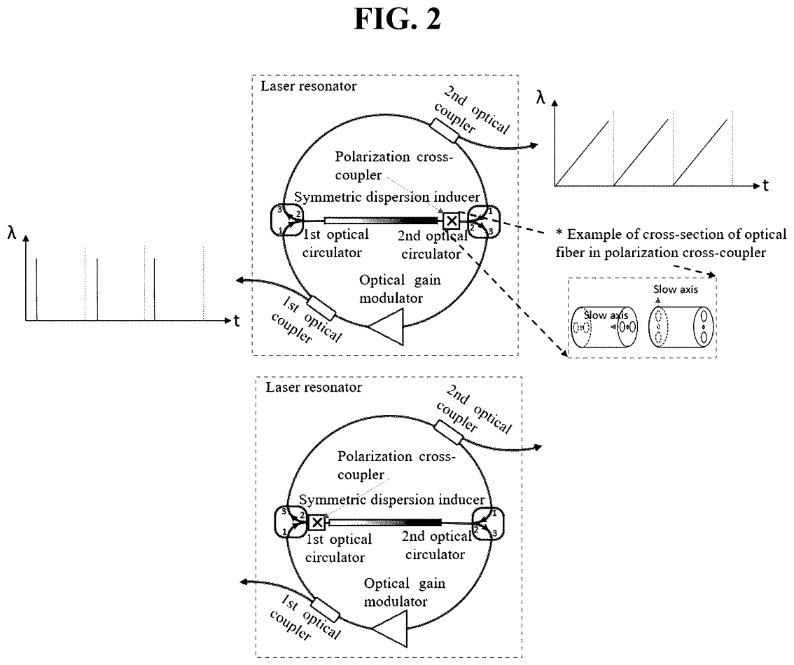

FIG. 2 is a diagram to illustrate the basic structure of a laser device that controls internal resonance using polarization cross-coupling of optical fibers according to the present disclosure.

The terminology used in the present disclosure has been selected as general terms that are as widely used as possible at present, considering the functions of the present disclosure, but these terms may vary depending on the intent of those skilled in the art, legal precedents, or the emergence of new technologies. Additionally, in certain cases, terms arbitrarily selected by the applicant may be used, and in such cases, the meanings of these terms will be described in detail in the relevant portions of the detailed description. Therefore, the terminology used in the present disclosure should not be interpreted based solely on the names of the terms, but should be defined based on the meanings they hold and the overall content of the present disclosure.

Throughout the specification, if a part “comprises” or “includes” a component, it means that it may further include other component rather than excluding other components unless the context indicates otherwise. Additionally, the terms such as “ . . . unit” or “module” described in the specification refer to a unit that performs at least one function or operation, and it may be implemented as hardware, software, or a combination of both.

The laser device that controls internal resonance using polarization cross-coupling of optical fibers according to the present disclosure may solve the problem of the laser output duty ratio being limited to 50% or less, which was caused by suppressing the lasing of light transmitted through the symmetric dispersion inducing optical element in the laser setup via the on/off control of the optical gain element.

To achieve this, the present disclosure may include a configuration that uses a polarization cross-coupler, which cross-couples the polarization axes perpendicularly, to suppress the resonance of light transmitted through the symmetric dispersion inducing optical element without on/off control of the optical gain element, thereby allowing the laser output duty ratio to be increased to over 50%.

The basic structure of the laser device that controls internal resonance using polarization cross-coupling of optical fibers according to the present disclosure, as shown in FIG. 2, primarily consists of polarization-maintaining optical fibers, and includes a laser resonator circulating light, an optical gain modulator generating broadband light with the laser resonator, a first optical circulator receiving light from the optical gain modulator at a first port, sending it to the symmetric dispersion inducer connected to a second port, receiving the stretched light from the symmetric dispersion inducer at the second port, and outputting it to a third port, a second optical circulator receiving light from the third port within the first optical circulator at a first port, sending it to the symmetric dispersion inducer connected to a second port, receiving the compressed light from the symmetric dispersion inducer at the second port, and outputting it to a third port, a symmetric dispersion inducer connected to the first optical circulator to induce the stretching of light and to the second optical circulator to induce the compression of light, a polarization cross-coupler suppressing internal resonance in a direction transmitted through the symmetric dispersion inducer via the corresponding optical circulator by connecting a polarization axis of polarization-maintaining optical fiber in either the second port of the first optical circulator or the second port of the second optical circulator perpendicularly to a polarization axis of polarization-maintaining optical fiber in the symmetric dispersion inducer, and one or more of either a first optical coupler, positioned in the laser resonator and outputting the compressed light to the outside, or a second optical coupler, positioned in the laser resonator and outputting the stretched light to the outside. Accordingly, the structure is one in which compression and stretching are repeated, which suppresses internal resonance in the direction transmitted through the symmetric dispersion inducer via polarization cross-coupling of optical fibers.

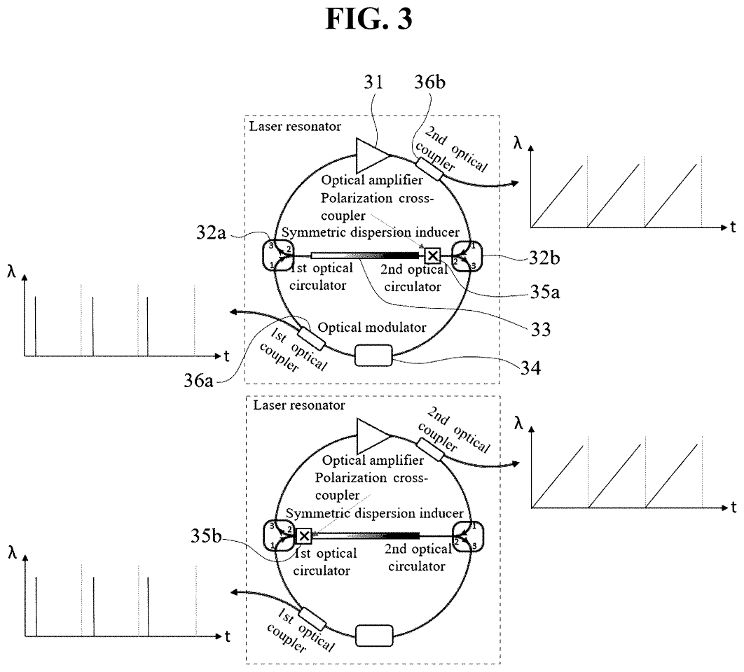

FIG. 3 is a diagram to illustrate the configuration of a laser device that controls internal resonance using polarization cross-coupling of optical fibers according to another embodiment of the present disclosure.

The laser device that controls internal resonance using polarization cross-coupling of optical fibers according to another embodiment of the present disclosure, as shown in FIG. 3, primarily consists of polarization-maintaining optical fibers and includes a laser resonator circulating light, an optical amplifier 31 generating broadband light with the laser resonator, a first optical circulator 32a receiving light from an optical modulator 34 at a first port, sending it to a symmetric dispersion inducer 33 connected to a second port, receiving the stretched light from the symmetric dispersion inducer 33 at the second port, and outputting it to a third port, a second optical circulator 32b receiving light from the third port within the first optical circulator 32a at a first port, sending it to the symmetric dispersion inducer 33 connected to a second port, receiving the compressed light from the symmetric dispersion inducer 33 at the second port, and outputting it to a third port, the symmetric dispersion inducer 33 connected to the first optical circulator 32a to induce the stretching of light and to the second optical circulator 32b to induce the compression of light, the optical modulator 34 positioned between the first port in the first optical circulator 32a and the third port in the second optical circulator 32b, generating the broadband light as pulsed light, polarization cross-couplers 35a, 35b suppressing internal resonance in a direction transmitted through the symmetric dispersion inducer 33 via the corresponding optical circulator by connecting a polarization axis of polarization-maintaining optical fiber in either the second port of the first optical circulator 32a or the second port of the second optical circulator 32b perpendicularly to a polarization axis of polarization-maintaining optical fiber in the symmetric dispersion inducer 33, and one or more of either a first optical coupler 36a positioned in the laser resonator and outputting the compressed light to the outside or a second optical coupler 36b positioned in the laser resonator and outputting the stretched light to the outside.

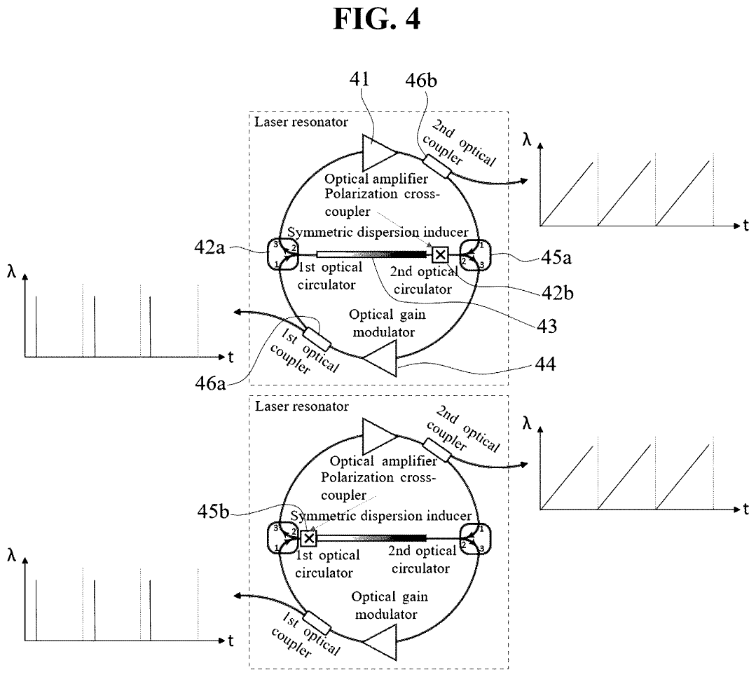

FIG. 4 is a diagram to illustrate the configuration of a laser device that controls internal resonance using polarization cross-coupling of optical fibers according to yet another embodiment of the present disclosure.

The laser device that controls internal resonance using polarization cross-coupling of optical fibers according to yet another embodiment of the present disclosure primarily consists of polarization-maintaining optical fibers and includes a laser resonator circulating light, an optical amplifier 41 generating broadband light with the laser resonator, a first optical circulator 42a receiving light from an optical gain modulator 44 at a first port, sending it to a symmetric dispersion inducer 43 connected to a second port, receiving the stretched light from the symmetric dispersion inducer 43 at the second port, and outputting it to a third port, a second optical circulator 42b receiving light from the third port within the first optical circulator 42a at a first port, sending it to the symmetric dispersion inducer 43 connected to a second port, receiving the compressed light from the symmetric dispersion inducer 43 at the second port, and outputting it to a third port, the symmetric dispersion inducer 43 connected to the first optical circulator 42a to induce the stretching of light and to the second optical circulator 42b to induce the compression of light, the optical gain modulator 44 positioned between the first port in the first optical circulator 42a and the third port in the second optical circulator 42b, generating the broadband light as pulsed light, polarization cross-couplers 45a, 45b suppressing internal resonance in a direction transmitted through the symmetric dispersion inducer 43 via the corresponding optical circulator by connecting a polarization axis of polarization-maintaining optical fiber in either the second port of the first optical circulator 42a or the second port of the second optical circulator 42b perpendicularly to a polarization axis of the polarization-maintaining optical fiber in the symmetric dispersion inducer 43, and one or more of either a first optical coupler 46a positioned in the laser resonator and outputting the compressed light to the outside or a second optical coupler 46b positioned in the laser resonator and outputting the stretched light to the outside.

Characterized by this structure, by using a polarization cross-coupler that cross-couples the polarization axes perpendicularly, it suppresses the resonance of light transmitted through the symmetric dispersion inducing optical element without on/off control of the optical gain element, allowing the laser output duty ratio to be increased to over 50%.

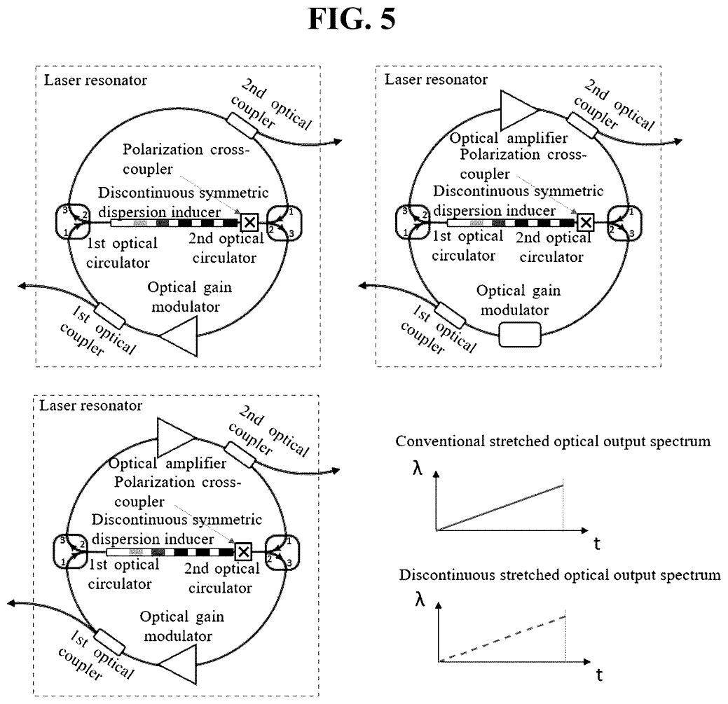

FIG. 5 is a diagram to illustrate the configuration of a laser device that includes a discontinuous symmetric dispersion inducer.

The laser device that controls internal resonance using polarization cross-coupling of optical fibers according to the present disclosure, as shown in FIG. 5, may be configured with a structure including a discontinuous symmetric dispersion inducer repeating compression and stretching of the light oscillated from the optical gain modulator discontinuously according to the wavelength instead of the symmetric dispersion inducer.

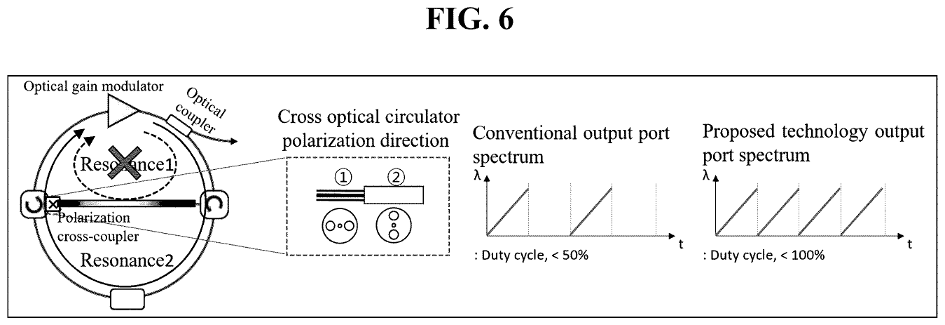

FIG. 6 is a diagram to illustrate the operational characteristics of a laser device that controls internal resonance using polarization cross-coupling of optical fibers according to the present disclosure.

By adding a polarization cross-coupler with polarization directions set perpendicularly, unwanted first resonance can be suppressed, and by suppressing the first resonance, the polarization cross-coupler can be used to make the duty cycle less than 100%, thereby solving the problem of the duty ratio being limited to 50% or less in conventional laser setups.

The laser device that controls internal resonance using polarization cross-coupling of optical fibers according to the present disclosure, as described above, is to solve the problem of the laser output duty ratio being limited to 50% or less, which was caused by suppressing the lasing of light transmitted through the symmetric dispersion inducing optical element in the laser setup via the on/off control of the optical gain element, and to increase the laser output duty ratio to over 50% by using a polarization cross-coupler that cross-couples the polarization axes perpendicularly, suppressing the resonance of light transmitted through the symmetric dispersion inducing optical element without on/off control of the optical gain element.

As described above, it will be understood that the present disclosure may be implemented in modified forms to the extent that it does not deviate from the essential characteristics of the present disclosure.

Therefore, the stated embodiments should be considered from an illustrative point of view rather than a limited one, and the scope of the present disclosure is indicated in the scope of the appended claims, not the foregoing description, and all differences within the equivalent scope should be interpreted as being included in the present disclosure.

### EXPLANATION OF SYMBOLS

31. Optical amplifier
32a.32b. Optical circulators
33. Symmetric dispersion inducer
34. Optical modulator
35a.35b. Polarization cross-couplers
36a.36b. Optical couplers

1. A laser device for controlling internal resonance using polarization cross-coupling of optical fibers, the laser device comprising:
a laser resonator comprising polarization-maintaining optical fibers;
an optical gain modulator configured to oscillate broadband light with the laser resonator;
a symmetric dispersion inducer repeating compression and stretching of the light oscillated from the optical gain modulator;
first and second optical circulators connecting the symmetric dispersion inducer to the laser resonator;
a polarization cross-coupler suppressing internal resonance in a direction transmitted through the symmetric dispersion inducer via the first and second optical circulators; and
an optical coupler making an output port by dividing the light amplified from the laser resonator at a constant ratio.

2. The laser device according to claim 1, wherein the first optical circulator receives light from the optical gain modulator at a first port and sends it to the symmetric dispersion inducer connected to a second port, and receives the stretched light from the symmetric dispersion inducer at the second port and outputs it to a third port, and
the second optical circulator receives light from the third port within the first optical circulator at a first port and sends it to the symmetric dispersion inducer connected to a second port, and receives the compressed light from the symmetric dispersion inducer at the second port and outputs it to a third port.

3. The laser device according to claim 1, wherein the symmetric dispersion inducer is connected to the first optical circulator to induce the stretching of light and is connected to the second optical circulator to induce the compression of light.

4. The laser device according to claim 1, wherein the polarization cross-coupler is configured such that a polarization axis of polarization-maintaining optical fiber in either a second port within the first optical circulator or a second port within the second optical circulator is connected in a direction perpendicular to a polarization axis of polarization-maintaining optical fiber in the symmetric dispersion inducer, thereby suppressing internal resonance in the direction transmitted through the symmetric dispersion inducer via the corresponding optical circulator.

5. The laser device according to claim 1, wherein the optical coupler comprises one or more of either a first optical coupler, positioned in the laser resonator and outputting the compressed light to the outside, or a second optical coupler, positioned in the laser resonator and outputting the stretched light to the outside.

6. The laser device according to claim 1, further comprising an optical modulator generating broadband light as pulsed light.

7. The laser device according to claim 1, further comprising an optical amplifier generating broadband light.

8. The laser device according to claim 1, further comprising a discontinuous symmetric dispersion inducer repeating compression and stretching of the light oscillated from the optical gain modulator discontinuously according to a wavelength instead of the symmetric dispersion inducer.

9. The laser device according to any one of claim 6, further comprising a discontinuous symmetric dispersion inducer repeating compression and stretching of the light oscillated from the optical gain modulator discontinuously according to a wavelength instead of the symmetric dispersion inducer.

10. The laser device according to any one of claim 7, further comprising a discontinuous symmetric dispersion inducer repeating compression and stretching of the light oscillated from the optical gain modulator discontinuously according to a wavelength instead of the symmetric dispersion inducer.
